(19) United States
(12) Patent Application Publication
(10) Pub. No.: US 2005/0023215 A1
(43) Pub. Date: Feb. 3, 2005

(54) Periodic aeration in an activated sludge reactor for wastewater treatment

(76) Inventors: Richard E. Bare, North Brunswick, NJ (US); Matthew J. Grossman, Flemington, NJ (US); Roger C. Prince, Pittstown, NJ (US); David William Savage, Zionsville, IN (US)

Correspondence Address: ExxonMobil Research and Engineering Company, P. O. Box 900, Annandale, NJ, 08801-0900, US

(21) Appl. No.: 10/629,247

(22) Filed: Jul. 29, 2003

(51) Int. Cl. C02F 3/30

(52) U.S. Cl. 210/605; 210/614; 210/903

(57) ABSTRACT

A method for treating wastewater. The method includes the steps of flowing the wastewater in the absence of any additional carbon source into a treatment basin in order to form the contents of the treatment basin and treat the wastewater, mixing the contents of the treatment basin, introducing oxygen into the treatment basin for a first predetermined time period of from about 10 to about 120 minutes, stopping the introduction of oxygen into the treatment basin for a second predetermined time period of from about 7.5 to 120 minutes, repeating the steps of introducing oxygen into the treatment basin for a first predetermined time period and stopping the introduction of oxygen into the treatment basin for a second predetermined time period a plurality of times, and flowing the treated wastewater out of the treatment basin into a clarifier, where treated wastewater is separated into clarified liquid effluent and sludge. Also provided is a process for reducing the level of nitrogen compounds in wastewater.

### FIELD

The present invention relates to the treatment of wastewater. More particularly, the invention relates to a process to reduce the level of nitrogen compounds in wastewater.

### BACKGROUND

The presence of nitrogen compounds in lakes, rivers and other water resources has received worldwide attention, because the presence of these nitrogen compounds in the environment is one of the primary causes of eutrophication. It is believed that these compounds promote unwanted growth of algae and other aquatic plants that consume dissolved oxygen. Consequently, there is increased demand to reduce nitrogen compounds in wastewater prior to discharge of the wastewater.

Recognizing the need to reduce the discharge of nitrogen compounds into the environment, a number of processes have been proposed for the denitrification of wastewater containing nitrogen compounds. Generally, such processes comprise passing wastewater containing nitrogen compounds, such as ammonia and organic nitrogen compounds, through a reactor vessel under aerobic conditions to oxidize the nitrogen compound into nitrites and nitrates and then passing the nitrified wastewater through another reactor vessel under anoxic conditions to denitrify the nitrified wastewater. Nitrogen containing gas, including elemental nitrogen, formed during denitrification is discharged, as is the treated wastewater effluent that has a reduced level of nitrogen compounds. Typically, such processes utilize a settling tank between the nitrification and denitrification reactor vessels or a settling tank or clarification zone after the wastewater being treated has been passed through the denitrification vessel.

Conventional aerobic treatment of refinery or chemical wastewater removes organic material and catalyzes nitrification or the removal of ammonia by microbial oxidation. A properly operating system will have little, if any, ammonia in the effluent but will have a buildup of nitrate. Since regulatory limits for nitrate discharge may become more stringent in the future, a cost-effective strategy for nitrate removal (denitrification) is desirable. Current technology for denitrification generally requires the construction of anaerobic tanks or zones required for the process in addition to the aerobic technology already in place. Often a carbon source such as methanol has to be added for microbial activity. In addition, there is interest in the Anammox process, anaerobic ammonia oxidation, in which anaerobic denitrifying bacteria use ammonium as an electron donor for nitrate reduction.

A normally operating wastewater treatment facility has two main purposes. The first is to remove organic compounds that are toxic, thereby reducing the overall carbon released to the environment. The second is to remove ammonia and other nitrogenous compounds, including nitrates, to regulatory limits. While the level of nitrates typically released has no significant toxic effect on the environment, the amount of nitrates released is a potential regulatory concern, since nitrates promote the unwanted growth of algae and other aquatic plants that consume dissolved oxygen. Although processes are available to reduce the level of nitrates in wastewater, such processes are either not easy to utilize or too expensive in order to retrofit or replace current technology in place.

U.S. Pat. No. 5,863,435 discloses a method for the biological treatment of ammonium-rich wastewater in at least one reactor by passing the wastewater through the reactor wherein during a first stage subjecting the wastewater to an infeed of oxygen and during a second stage while stopping the feed of oxygen adding a carbon source, such as methanol.

U.S. Pat. No. 6,113,787 discloses a method for treating wastewater comprising the steps of subjecting compounds in the water difficult to degrade by the biological degradation process to destruction by catalytic cracking or an oxidation process, then placing the water alternately into aerobic and anaerobic states, subsequently ultrafiltering the water from the alternate treatment step, nano-filtering the water after the ultrafiltration step, separating retent during the ultrafiltration and/or nano-filtration steps ad feeding the retent to the step in which the water is alternately placed into the aerobic and anaerobic states, and feeding compounds contained in the retent from nano-filtration step and which are difficult to degrade by biological degradation process to the step of subjecting the compounds to destruction by the catalytic cracking or oxidation process and subsequently feeding the same to the step in which the water is alternately placed into the aerobic and anaerobic states.

U.S. Pat. No. 6,426,004 discloses a method for treating wastewater comprising the steps of continuously flowing an influent into a treatment basin, continuously flowing an effluent out of the treatment basin into a clarifier, continuously completely mixing the influent in the treatment basin, introducing oxygen into the treatment basin for a first predetermined time period from 15 minutes to 4 hours, stopping the introduction of oxygen into the basin for a second predetermined time period from 15 minutes to 4 hours and then repeating the steps of introducing and stopping the oxygen. The method further comprises introducing into the treatment basin for a third predetermined time period a supplemental source of carbon, such as methanol, ethylene glycol, simple sugars or additional concentrated wastewater which wastewater has little or no nitrogen in it, with the third predetermined time period being no greater than the second predetermined time period.

U.S. Pat. No. 5,776,344 discloses a process for treating wastewater containing nitrogen compounds, comprising the steps of passing the wastewater through a biologically active material maintained under substantially aerobic conditions to oxidize at least a portion of the nitrogen compounds in the wastewater to nitrites and nitrates to provide nitrified wastewater and passing the nitrified wastewater through the same biologically active material maintained under substantially anoxic conditions to reduce at least a portion of the nitrites and nitrates in the nitrified wastewater to gaseous nitrogen.

Other processes for treating wastewater are discussed in the following patents. U.S. Pat. No. 5,266,200 discloses a sequence continuous reaction process for consistently removing biochemical oxygen demand, for removing ammonia by nitrification, and for removing both nitrites and nitrates by denitrification from ammonia-contaminated wastewater. U.S. Pat. No. 4,663,044 discloses a continuous inflow, intermittent flow path, sequential cycle, activated sludge wastewater process for treating wastewater. U.S. Pat. No. 4,655,925 discloses a process for removing nitrogen and phosphorus from wastewater by using activated sludge including aerobic bacteria and changing alternately operational modes in a treatment basis in accordance with a time schedule. U.S. Pat. No. 4,917,805 discloses a process for nitrification and denitrification of ammonia-contaminated wastewater.

### SUMMARY

The present invention relates to the treatment of wastewater and in particular to a process for reducing the level of nitrogen compounds in wastewater. The method includes the steps of flowing the wastewater in the absence of any additional carbon source into a treatment basin in order to form the contents of the treatment basin and treat the wastewater, mixing the contents of the treatment basin, introducing oxygen into the treatment basin for a first predetermined time period of from about 10 to about 120 minutes, stopping the introduction of oxygen into the treatment basin for a second predetermined time period of from about 7.5 to 120 minutes, repeating the steps of introducing oxygen into the treatment basin for a first predetermined time period and stopping the introduction of oxygen into the treatment basin for a second predetermined time period a plurality of times, and flowing the treated wastewater out of the treatment basin into a clarifier, where treated wastewater is separated into clarified liquid effluent and sludge.

Also provided is a process for reducing the level of nitrogen compounds in wastewater. The process includes the steps of flowing the wastewater in the absence of any additional carbon source into a treatment basin in order to form the contents of the treatment basin and treat the wastewater, mixing the contents of the treatment basin, introducing oxygen into the treatment basin for a first predetermined time period of from about 10 to about 120 minutes, stopping the introduction of oxygen into the treatment basin for a second predetermined time period of from about 7.5 to 120 minutes, repeating the steps of introducing oxygen into the treatment basin for a first predetermined time period and stopping the introduction of oxygen into the treatment basin for a second predetermined time period a plurality of times and flowing the treated wastewater out of the treatment basin, wherein the treated wastewater flowing from the treatment basin has a nitrate level of less than 5 ppm .

### BRIEF DESCRIPTION OF THE DRAWINGS

The invention will now be described in more detail with reference to preferred forms, given only by way of example, and with reference to the accompanying drawings, in which:

FIG. 1 is a schematic illustration of an embodiment of an apparatus for conducting the process of the invention.

FIG. 2 shows the dissolved oxygen concentration during cycles of 15 minutes (each) air on, air off, compared to the control reactor.

FIG. 3 shows a comparison of total nitrogen levels in the effluents of the control and test reactors with that of the feed over time.

FIG. 4 shows a comparison of nitrate levels in the effluents of the control and test reactors over time.

FIG. 5 shows an ion-chromatograph comparison between the control and test reactors.

### DETAILED DESCRIPTION

The particulars shown herein are by way of example and for purposes of illustrative discussion of the various embodiments of the present invention only and are presented in the cause of providing what is believed to be the most useful and readily understood description of the principles and conceptual aspects of the invention. In this regard, no attempt is made to show details of the invention in more detail than is necessary for a fundamental understanding of the invention, the description taken with the drawings making apparent to those skilled in the art how the several forms of the invention may be embodied in practice.

All percent measurements in this application, unless otherwise stated, are measured by weight based upon 100% of a given sample weight. Thus, for example, 30% represents 30 weight parts out of every 100-weight parts of the sample.

Unless otherwise stated, a reference to a compound or component includes the compound or component by itself, as well as in combination with other compounds or components, such as mixtures of compounds.

As discussed above, the present invention relates to a process for treating wastewater containing nitrogen compounds, and, in particular, an alternative process in which an activated sludge reactor is allowed to cycle between aerobic and anaerobic periods. In seeking optimal aerobic/anaerobic cycling periods, it is advantageous to minimize the anaerobic period to insure adequate TOC removal and avoid times that may be detrimental for microbial survival.

The aerobic period can be selected from a range of from about 10 to about 120 minutes, preferably from about 10 minutes to about 22.5 minutes, more preferably from about 10 minutes to about 20 minutes, with from about 14 minutes to about 16 minutes being most preferred. The anaerobic period can be selected from a range of from about 7.5 to 120 minutes, preferably from about 7.5 minutes to about 20 minutes, more preferably from about 10 minutes to about 20, and most preferably from about 14 minutes to about 16 minutes. The aerobic and anaerobic periods can be the same or different time periods. While one skilled in the art can determine such a period by routine experimentation, it has been discovered that aerobic/anaerobic cycling of about 15 minutes aerobic and about 15 minutes anaerobic provides the best system efficacy.

Moreover, the present process does not require the addition of any carbon source to the normal feed. After an acclimatization period (normally about 1 week), the process results in the removal of nitrates to <5 ppm or a greater than 50 fold reduction from levels in a continuously aerated reactor. The process can continue to remove ammonia (to <1 ppm) and total Kjeldahl nitrogen (to <5 ppm), levels seen in a totally aerobic system.

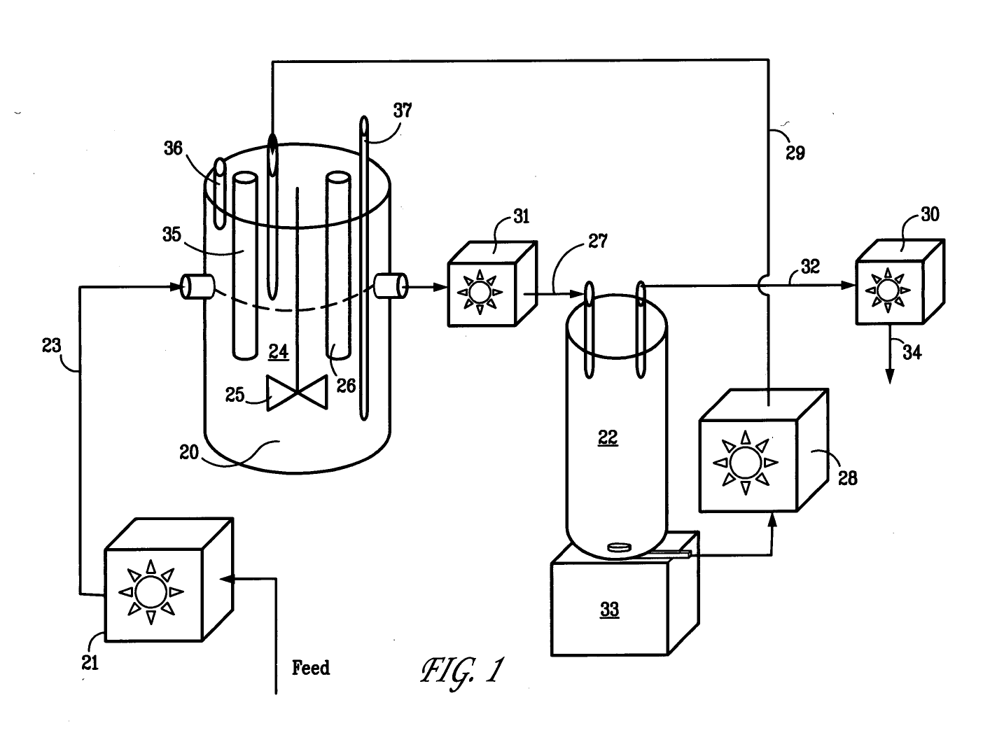

FIG. 1 depicts a continuous flow wastewater treatment reactor system in accordance with an embodiment of the present invention. The wastewater treatment reactor system comprises treatment basin 20 and clarifier 22. Pump 21 and influent delivery pipe 23 deliver influent wastewater from a facility (not shown) to treatment basin 20. The influent wastewater mixes with the mixed liquor 24 already in basin 20. The capacity of treatment basin 20 may be variable. For example, the present invention can be used with a basin having a capacity of several million gallons of liquid. A plurality of mixers 25 with their associated motors (not depicted) ensures that the mixed liquor 24 is mixed at all times. As would be understood by one of ordinary skill in the art, mixers 25 can comprise a variety of configurations including overhead mounted platforms and combined with aerators.

A plurality of dissolved oxygen controllers (aerators) 26 is located in basin 20. As will be understood by one of ordinary skill in the art, oxygen controllers 26 can comprise a variety of configurations including floating aerators, platforms and combined jet aerators/mixers. A supply line (not shown) can connect oxygen controllers 26 to a source of oxygen, such as pure oxygen, air or a mixture thereof. A sparger line 37 may also be provided. As an embodiment of the invention, a controller can be operably connected to the oxygen controllers to both control and regulate the release of oxygen into the treatment basin. In addition, the oxygen controller may further comprise a microprocessor connected to a valve in order to automatically regulate the oxygen level. On the other hand, the oxygen controller may comprise a valve that is operated manually in order to regulate the flow of oxygen into basin 22 so that the oxygen can be cycled on and off. In either case, the introduction of oxygen into the treatment basin can be controlled to a value within the preferred range of from about 40 to about 60 percent for the aerobic period. One or more pH probes 35 may be positioned within basin 20 to monitor the pH condition of basin 20. A base addition line may also be provided for adjustment.

A portion of the mixed liquor 24 is withdrawn by pump 31 through clarifier feed line 27 and into clarifier 22. The contents of clarifier 22 are stirred using stirrer 33. Stirrer 33 is provided to address the fact that as one recycles settled sludge, often a “hole” in the settled sludge develops around the exit to return line 29. As such, gentle stirring is required to inhibit the formation of this hole. On the other hand, as those skilled in the art will recognize, stirrer 33 cannot stir too strongly as the sludge will not properly settle. In large scale settling basins, stirrer 33 can be a mechanical rake-type apparatus.

In clarifier 22, the mixed liquor 24 can be separated into clarified liquid effluent and sludge. The clarified effluent can flow out of the clarifier into a discharge stream or it can be recirculated for other uses. As shown in FIG. 1, clarified effluent is withdrawn through line 32 using pump 30 and discharged through line 34. The sludge can be removed from clarifier 22 through pump 28, which can recycle the sludge through sludge return line 29 into treatment basin 20. In an embodiment of the present invention, the sludge can be delivered to influent delivery pipe 26 for recirculation. In general, the solids content in treatment basin 20 is from about 0.2% to about 1.0% while the solids content in clarifier 22 may be from about 1% to 4%.

As those skilled in the art recognize, wastewater systems are not temperature controlled and their temperatures vary over the course of a year to reflect seasonal climate variations. As such, it would be expected that the prevailing temperature of a wastewater system would vary from about 5° C. to about 35° C. Likewise, it would be expected that a typical refinery wastewater stream would contain a minor amount of PO₄ as phosphoric acid, with an amount on the order of about 50 ppm considered typical. Also, with respect to the range of pH values typically encountered in wastewater treatment facilities, a pH range of about from 7.0 to about 8.2 would be expected.

As may be appreciated by those skilled in the art, the systems described herein include constant flow systems. Such systems are modeled on the basis of a hydraulic retention time, which is calculated as follows:
HRT(hr)=V×24/Fr)
where: HRT is the hydraulic retention time;
V is the volume of aeration tank; and
FR is the flow rate of influent.
   Constant flow systems designed in accordance with the present invention will yield constant flows of effluent having levels of TOC, ammonia, nitrate and nitrite that are within operating parameters.

The present invention will be further illustrated by way of the following Example. This example is non-limiting and does not restrict the scope of the invention.

Unless stated otherwise, all percentages, parts, etc. presented in the examples are by weight.

### EXAMPLE

A commercially available bioreactor, the Bioflo 3000 with a 1.25 Liter vessel (New Brunswick Scientific (NBS), Edison, N.J.), is used as a wastewater treatment simulator. The bioreactor is equipped with agitation, temperature, pH, and dissolved oxygen controllers in addition to pumps used for feed addition, level control and sludge return. A clarifier (about 1 Liter in volume) is constructed for sludge return and effluent removal. Feed to the reactor is an approximate 50:50 mixture of stripped sour water (SSW) and effluent from the iso-static flotation (ISF) from the Benicia, Calif. refinery supplemented with about 50 ppm PO4 as phosphoric acid. This mixture is representative of the feed to the Benicia BIOX (biological oxidation) wastewater system. The rate of feed is about 100 ml/min with a resulting hydraulic retention time of 10-12 hours. The temperature is maintained at 34E C. and the pH is maintained at 7.3 with the addition of 0.2 N NaOH. The cycle period for airflow was controlled by AFS software supplied by NBS for operation of the bioreactor. Airflow is manually set at 2 liter/min. A control reactor with identical conditions and feed without any air cycling is used for comparison.

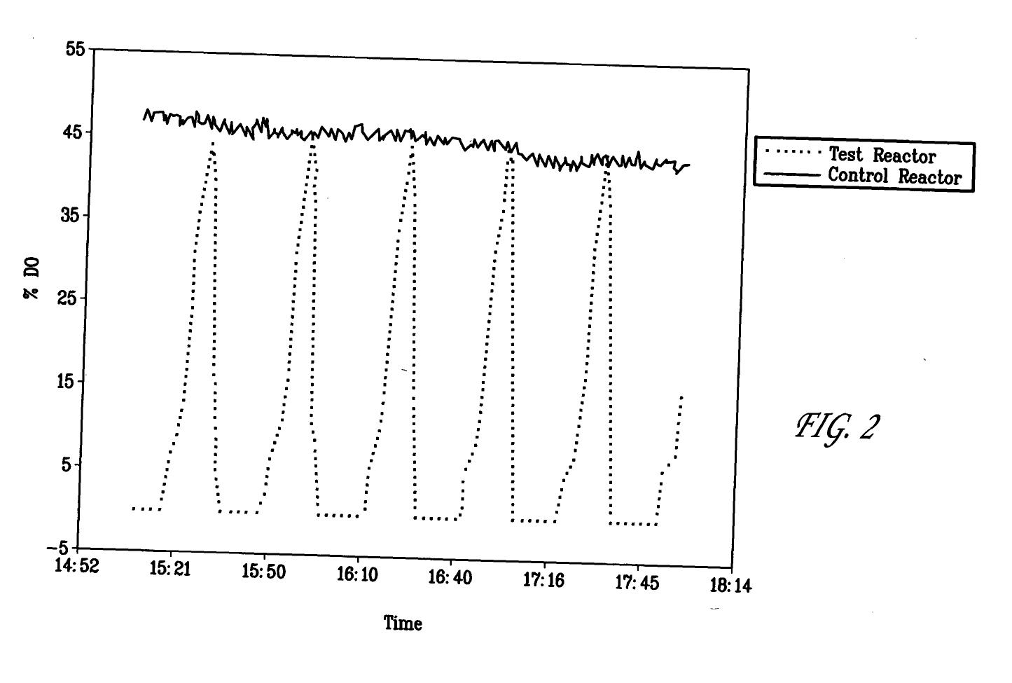

The results of the experiments are depicted in FIGS. 2 to 5 and the data for the experiments are set forth in Tables 1 to 3, below.

Table 1, below presents dissolved oxygen concentration data obtained during periodic cycling of 15 minutes air on, 15 minutes air off. The data so obtained is compared to the dissolved oxygen concentration data obtained for the control reactor.

TABLE 1
Dissolved Oxygen Vs. Time

| | |
|---|---|
| Time | Dissolved O₂ |

| (Hr:Min) | (Control) | (Test) |
|---|---|---|
| 15:09 | 46.9 | 0 |
| 15:10 | 48.1 | 0 |
| 15:11 | 46.8 | 0 |
| 15:12 | 47.8 | 0 |
| 15:15 | 47.8 | 0 |
| 15:15 | 46.9 | 0 |
| 15:15 | 47.7 | 0 |
| 15:16 | 46.7 | 0 |
| 15:17 | 47.5 | 0.1 |
| 15:20 | 47.5 | 6.8 |
| 15:20 | 46.4 | 7 |
| 15:20 | 47.6 | 7.1 |
| 15:21 | 46.6 | 7.9 |
| 15:22 | 47.2 | 9.9 |
| 15:24 | 47.5 | 13.7 |
| 15:24 | 46.2 | 19 |
| 15:25 | 48.1 | 24.4 |
| 15:26 | 46.6 | 31 |
| 15:27 | 46.6 | 36.1 |
| 15:28 | 47.5 | 39.2 |
| 15:29 | 46.2 | 43.5 |
| 15:30 | 47.4 | 44.2 |
| 15:31 | 46.2 | 39.6 |
| 15:32 | 45.9 | 18.5 |
| 15:33 | 47.1 | 4.3 |
| 15:35 | 45.6 | 0 |
| 15:36 | 47 | 0 |
| 15:36 | 45.8 | 0 |
| 15:37 | 46.2 | 0 |
| 15:39 | 46.9 | 0 |
| 15:40 | 45.4 | 0 |
| 15:41 | 46.3 | 0 |
| 15:41 | 45.8 | 0 |
| 15:42 | 45.1 | 0 |
| 15:43 | 47.5 | 0 |
| 15:45 | 46 | 0 |
| 15:45 | 47.4 | 0 |
| 15:46 | 47.4 | 0 |
| 15:47 | 45.1 | 0 |
| 15:49 | 46.3 | 2.3 |
| 15:50 | 45.3 | 6.6 |
| 15:50 | 46.1 | 6.8 |
| 15:51 | 46.4 | 7.6 |
| 15:52 | 45.1 | 9.1 |
| 15:54 | 46.2 | 13.7 |
| 15:55 | 45.8 | 21.7 |
| 15:56 | 45.7 | 23.3 |
| 15:56 | 46.3 | 27.3 |
| 15:57 | 44.9 | 34.3 |
| 16:00 | 46.2 | 43.6 |
| 16:00 | 45.3 | 43.9 |
| 16:00 | 44.9 | 44.3 |
| 16:01 | 46.1 | 44.8 |
| 16:02 | 45.3 | 33.2 |
| 16:03 | 46.7 | 10.2 |
| 16:05 | 45.7 | 0 |
| 16:05 | 45.6 | 0 |
| 16:06 | 46.5 | 0 |
| 16:07 | 45.1 | 0 |
| 16:08 | 46.4 | 0 |
| 16:10 | 45.8 | 0 |
| 16:10 | 45 | 0 |
| 16:11 | 46.2 | 0 |
| 16:12 | 45.3 | 0 |
| 16:13 | 47 | 0 |
| 16:15 | 47.2 | 0 |
| 16:16 | 46.3 | 0 |
| 16:16 | 46.7 | 0 |
| 16:17 | 45.2 | 0 |
| 16:19 | 46.2 | 0.6 |
| 16:20 | 46.6 | 6.5 |
| 16:21 | 45.3 | 7 |
| 16:21 | 46.7 | 7.1 |
| 16:22 | 45.4 | 8.2 |
| 16:23 | 46.2 | 10.3 |
| 16:25 | 46.6 | 13.8 |
| 16:26 | 45.3 | 22.8 |
| 16:26 | 46.7 | 24.5 |
| 16:27 | 45.4 | 31.3 |
| 16:28 | 46.1 | 36.2 |
| 16:30 | 46.8 | 41.7 |
| 16:31 | 45.5 | 44.2 |
| 16:31 | 46.7 | 44.6 |
| 16:32 | 45.4 | 39.4 |
| 16:33 | 45.7 | 18.6 |
| 16:35 | 46.5 | 1.1 |
| 16:35 | 45.1 | 0.1 |
| 16:36 | 45.9 | 0 |
| 16:37 | 45.2 | 0 |
| 16:38 | 45 | 0 |
| 16:39 | 46 | 0 |
| 16:41 | 45.1 | 0 |
| 16:41 | 45.9 | 0 |
| 16:42 | 45.2 | 0 |
| 16:43 | 45.9 | 0 |
| 16:46 | 45.9 | 0 |
| 16:47 | 44.6 | 0 |
| 16:49 | 45.3 | 0.4 |
| 16:49 | 45.3 | 1.1 |
| 16:49 | 44.9 | 2.2 |
| 16:50 | 45.8 | 5.7 |
| 16:51 | 45 | 6.9 |
| 16:52 | 45.4 | 7.5 |
| 16:53 | 45.7 | 8.8 |
| 16:55 | 44.8 | 11.8 |
| 16:55 | 45.7 | 16.5 |
| 16:56 | 44.7 | 21.1 |
| 16:57 | 45.8 | 28 |
| 16:58 | 45.7 | 34 |
| 17:00 | 44.9 | 38.1 |
| 17:00 | 45.6 | 41.7 |
| 17:01 | 44.7 | 43.7 |
| 17:02 | 45 | 44.5 |
| 17:03 | 45.6 | 30.7 |
| 17:04 | 44.2 | 20.2 |
| 17:05 | 44.3 | 0.3 |
| 17:06 | 43.7 | 0 |
| 17:07 | 43.5 | 0 |
| 17:08 | 44.4 | 0 |
| 17:10 | 43 | 0 |
| 17:10 | 44.2 | 0 |
| 17:11 | 43.4 | 0 |
| 17:12 | 43 | 0 |
| 17:13 | 44 | 0 |
| 17:14 | 42.8 | 0 |
| 17:15 | 43.9 | 0 |
| 17:16 | 43.4 | 0 |
| 17:17 | 42.5 | 0 |
| 17:18 | 43.9 | 0 |
| 17:20 | 42.5 | 2.4 |
| 17:20 | 43.4 | 3.7 |
| 17:21 | 43.4 | 5.6 |
| 17:22 | 42.6 | 6.6 |
| 17:23 | 44 | 7.3 |
| 17:25 | 42.7 | 11.8 |
| 17:26 | 43.5 | 16.8 |
| 17:26 | 44.3 | 18.3 |
| 17:27 | 43.2 | 21.5 |
| 17:28 | 44.6 | 30 |
| 17:30 | 43.4 | 38.6 |
| 17:30 | 44.2 | 39.6 |
| 17:31 | 44.5 | 41.7 |
| 17:32 | 43.3 | 43.9 |
| 17:33 | 44.4 | 38.3 |
| 17:35 | 43.3 | 5.8 |
| 17:36 | 43.6 | 0.1 |
| 17:36 | 44.5 | 0.1 |
| 17:37 | 43.4 | 0 |
| 17:38 | 44 | 0 |
| 17:39 | 43.5 | 0 |
| 17:40 | 43.3 | 0 |
| 17:41 | 44.8 | 0 |
| 17:42 | 43.1 | 0 |
| 17:43 | 43.8 | −0.1 |
| 17:46 | 43.1 | 0 |
| 17:46 | 43.1 | 0 |
| 17:47 | 44 | 0 |
| 17:48 | 43.4 | 0 |
| 17:50 | 43.9 | 0.1 |
| 17:52 | 43.8 | 6.3 |
| 17:52 | 43 | 6.5 |
| 17:52 | 43.9 | 6.8 |
| 17:53 | 42.4 | 7.1 |
| 17:55 | 43.5 | 8.2 |
| 17:56 | 43.6 | 15.3 |

FIG. 2 graphically presents the dissolved oxygen concentration data obtained during the periodic cycling of 15 minutes air on, 15 minutes air off to the dissolved oxygen concentration data obtained for the control reactor.

Table 2 presents a comparison of total nitrogen levels in the effluents of the control and test reactors with that of the feed over time. The nitrogen content of the feed was approximately 80 ppm.

TABLE 2
Comparison of Total Nitrogen (N) Levels

| Test | Effluent Total N | Effluent Total N | Total N |
|---|---|---|---|
| Day No. | Control Reactor | Test Reactor | Feed |
| 1 | 59.4 | 56.6 | |
| 2 | 57.8 | 54.5 | |
| 5 | 50.0 | 52.9 | |
| 7 | 51.1 | 53.6 | |
| 8 | | | 90.1 |
| 12 | 54.4 | | |
| 13 | 51.6 | 32.2 | |
| 14 | 50.8 | 18.9 | |
| 15 | 52.9 | 6.0 | |
| 16 | 52.6 | 5.4 | |
| 20 | 52.6 | 11.8 | 76.3 |
| 26 | 49.4 | 4.0 | |
| 30 | 52.8 | 4.4 | |
| 33 | 50.1 | 3.7 | |
| 34 | 53.4 | 4.4 | |
| 40 | 44.7 | 5.9 | |
| 41 | 56.2 | 6.4 | 86.1 |

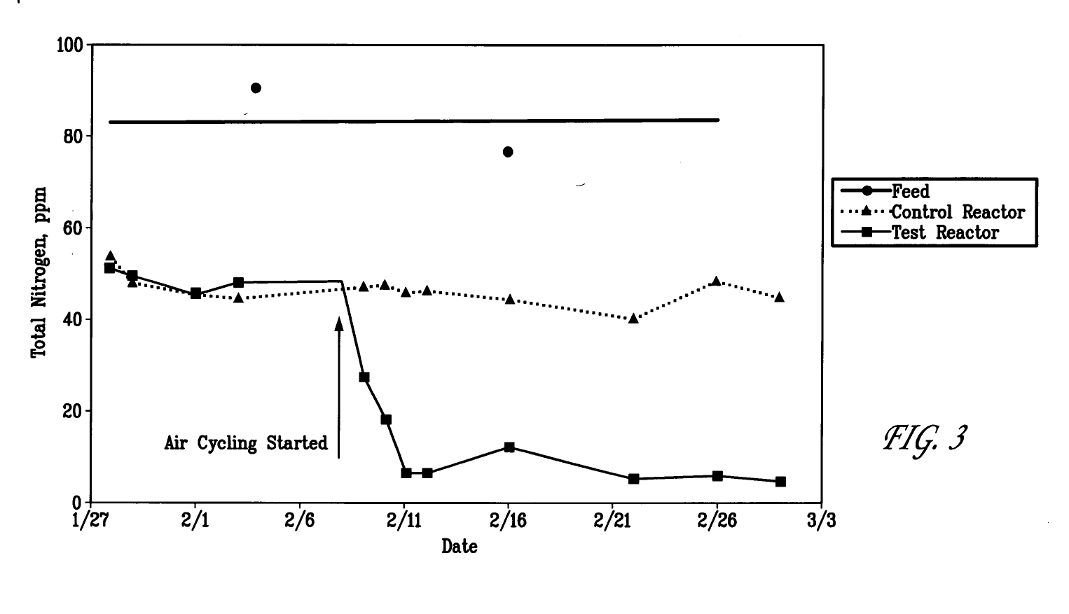

FIG. 3 graphically depicts the total nitrogen levels in the effluents of the control and test reactors with that of the feed over time. As shown, after about one week, the nitrogen content reduces to a level of about 10% of that in the feed.

Note that, as used herein, total nitrogen is defined as follows:
Total N=Kjeldahl-N+(NO₃)—N+(NO₂)—N.

Table 3 presents nitrate level data for the effluents of the control and test reactors over time. The nitrate level in the feed averaged about 2 ppm.

Comparison of Nitrate Levels

| Test | Effluent Nitrate | Effluent Nitrate |
|---|---|---|
| Day No. | Control Reactor | Test Reactor |
| 1 | 237.5 | 232.1 |
| 2 | 233.9 | 222.6 |
| 5 | 201.2 | 217.3 |
| 7 | 203.5 | 216.4 |
| 12 | 222.1 | |
| 13 | 211.6 | 57.5 |
| 14 | 210.9 | 22.5 |
| 15 | 218.4 | 8.2 |
| 16 | 218.8 | 5.5 |
| 20 | 214.8 | 23.7 |
| 26 | 199.0 | 0.0 |
| 30 | 217.5 | 0.0 |
| 33 | 203.1 | 0.0 |
| 40 | 177.2 | 0.0 |
| 41 | 224.2 | 0.0 |

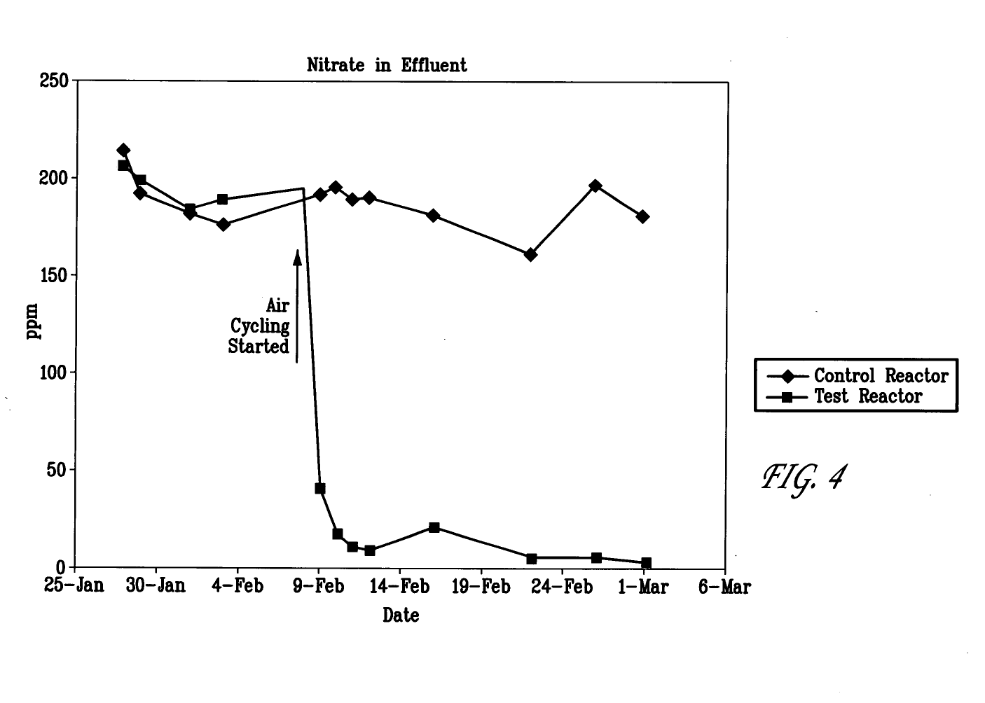

FIG. 4 presents a comparison of nitrate levels in the effluents of the control and test reactors over time for the data presented in Table 3. Most of the nitrogen was from ammonia (17-20 ppm) or other inorganic or organic nitrogen containing compounds such as thiocyanates (up to 500 ppm or more), whereas the nitrate level after the inventive process is run for about a week ranges from about 0 to about 6, with an average of 2.33±2.05.

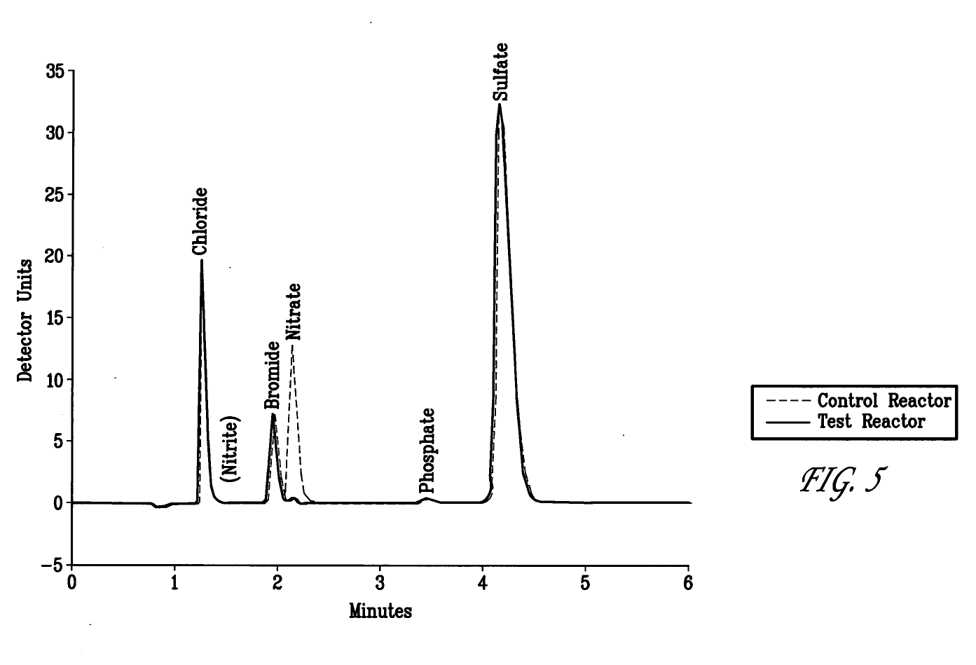

FIG. 5 shows an ion-chromatograph comparison between the control and test reactors. FIG. 5 clearly demonstrates the difference in nitrate concentrations between the two reactors. It is important to note the lack of nitrite formation in either reactor.

While the invention has been described in detail with reference to preferred embodiments thereof, it will be apparent to one skilled in the art that various changes can be made, and equivalents employed, without departing from the scope of the invention.

1. A method for treating wastewater in the absence of any additional carbon source comprising:
(a) flowing the wastewater in the absence of any additional carbon source into a treatment basin in order to form the contents of the treatment basin and treat the wastewater;
(b) mixing the contents of the treatment basin;
(c) introducing oxygen into the treatment basin for a first predetermined time period of from about 10 to about 120 minutes;
(d) stopping the introduction of oxygen into the treatment basin for a second predetermined time period of from about 7.5 to 120 minutes;
(e) repeating said steps (c) and (d) a plurality of times; and
(f) flowing the treated wastewater out of the treatment basin into a clarifier, where treated wastewater is separated into clarified liquid effluent and sludge.

2. The method of claim 1 further comprising recycling the sludge into the treatment basin.

3. The method of claim 2 wherein the treated wastewater flowing from the treatment basin has a nitrate level of less than 5 ppm.

4. The method of claim 1 wherein the treated wastewater flowing from the treatment basin has a nitrate level of less than 5 ppm.

5. The method of claim 1 wherein the treated wastewater flowing from the treatment basin has a nitrate level of less than 1 ppm.

6. The method of claim 1 wherein said first predetermined time period is substantially the same as said second predetermined time period.

7. The method of claim 1 further comprising measuring the oxygen content in the basin and controlling the introduction of oxygen into the treatment basin such that a concentration of oxygen in the range of about 40 to about 60 percent is maintained for the first predetermined time period.

8. The method of claim 1 wherein the temperature ranges from about 5° C. to about 35° C.

9. The method of claim 1 wherein the wastewater comprises about 50 ppm PO₄ as phosphoric acid.

10. The method of claim 1 wherein the pH is maintained in the range of about 7.0 to about 8.2.

11. The method of claim 1 wherein the first predetermined time period is different from the second predetermined time period.

12. The method of claim 1, wherein said first predetermined time period of said step of introducing oxygen into the treatment basin is from about 10 to about 22.5 minutes.

13. The method of claim 12, wherein said second predetermined time period of said step of stopping the introduction of oxygen into the treatment basin is from about 7.5 to about 20 minutes.

14. The method of claim 1, wherein said second predetermined time period of said step of stopping the introduction of oxygen into the treatment basin is from about 7.5 to about 20 minutes.

15. The method of claim 1, wherein said first predetermined time period of said step of introducing oxygen into the treatment basin is from about 10 to about 20 minutes.

16. The method of claim 15, wherein said second predetermined time period of said step of stopping the introduction of oxygen into the treatment basin is from about 10 to about 20 minutes.

17. The method of claim 1, wherein said second predetermined time period of said step of stopping the introduction of oxygen into the treatment basin is from about 10 to about 20 minutes.

18. The method of claim 1, wherein said first predetermined time period of said step of introducing oxygen into the treatment basin is from about 14 to about 16 minutes.

19. The method of claim 18, wherein said second predetermined time period of said step of stopping the introduction of oxygen into the treatment basin is from about 14 to about 16 minutes.

20. The method of claim 1, wherein said second predetermined time period of said step of stopping the introduction of oxygen into the treatment basin is from about 14 to about 16 minutes.

21. The method of claim 1, wherein said first predetermined time period of said step of introducing oxygen into the treatment basin and said second predetermined time period of said step of stopping the introduction of oxygen into the treatment basin are each about 15 minutes.

22. A process for reducing nitrogen compound levels in wastewater in the absence of additional carbon source, comprising the steps of:
(a) flowing the wastewater in the absence of any additional carbon source into a treatment basin in order to form the contents of the treatment basin and treat the wastewater;
(b) mixing the contents of the treatment basin;
(c) introducing oxygen into the treatment basin for a first predetermined time period of from about 10 to about 120 minutes;
(d) stopping the introduction of oxygen into the treatment basin for a second predetermined time period of from about 7.5 to 120 minutes;
(e) repeating said steps (c) and (d) a plurality of times; and
(f) flowing the treated wastewater out of the treatment basin;
wherein the treated wastewater flowing from the treatment basin has a nitrate level of less than 5 ppm.

23. The process of claim 22 wherein the treated wastewater flowing from the treatment basin has a nitrate level of less than 1 ppm.

24. The process of claim 23 wherein said first predetermined time period is substantially the same as said second predetermined time period.

25. The process of claim 22 wherein said first predetermined time period is substantially the same as said second predetermined time period.

26. The process of claim 22 further comprising measuring the oxygen content in the basin and controlling the introduction of oxygen into the treatment basin such that a concentration of oxygen in the range of about 40 to about 60 percent is maintained for the first predetermined time period.

27. The process of claim 22 wherein the temperature ranges from about 5° C. to about 35° C.

28. The process of claim 22 wherein the wastewater comprises about 50 ppm PO₄ as phosphoric acid.

29. The process of claim 22 wherein the pH is maintained in the range of about 7.0 to about 8.2.

30. The process of claim 22 wherein the first predetermined time period is different from the second predetermined time period.

31. The process of claim 22, wherein said first predetermined time period of said step of introducing oxygen into the treatment basin is from about 10 to about 22.5 minutes.

32. The process of claim 31, wherein said second predetermined time period of said step of stopping the introduction of oxygen into the treatment basin is from about 7.5 to about 20 minutes.

33. The process of claim 22, wherein said second predetermined time period of said step of stopping the introduction of oxygen into the treatment basin is from about 7.5 to about 20 minutes.

34. The process of claim 22, wherein said first predetermined time period of said step of introducing oxygen into the treatment basin is from about 10 to about 20 minutes.

35. The process of claim 34, wherein said second predetermined time period of said step of stopping the introduction of oxygen into the treatment basin is from about 10 to about 20 minutes.

36. The process of claim 22, wherein said second predetermined time period of said step of stopping the introduction of oxygen into the treatment basin is from about 10 to about 20 minutes.

37. The process of claim 22, wherein said first predetermined time period of said step of introducing oxygen into the treatment basin is from about 14 to about 16 minutes.

38. The process of claim 37, wherein said second predetermined time period of said step of stopping the introduction of oxygen into the treatment basin is from about 14 to about 16 minutes.

39. The process of claim 22, wherein said second predetermined time period of said step of stopping the introduction of oxygen into the treatment basin is from about 14 to about 16 minutes.

40. The process of claim 22, wherein said first predetermined time period of said step of introducing oxygen into the treatment basin and said second predetermined time period of said step of stopping the introduction of oxygen into the treatment basin are each about 15 minutes.
